(19) United States
(12) Patent Application Publication
(10) Pub. No.: US 2016/0361772 A1
(43) Pub. Date: Dec. 15, 2016

(54) PELLET MILL ROLLER SHELL HARD COATING AND METHOD OF APPLYING HARD COATING

(71) Applicant: JACOBS CORPORATION, Harlan, IA (US)

(72) Inventors: CHAD J. PLUMB, Harlan, IA (US); TODD K. PLUMB, Harlan, IA (US); Gavin Yongwei Guan, Liyang City (CN); BORIS GAO, Shanghai (CN)

(21) Appl. No.: 14/739,718

(22) Filed: Jun. 15, 2015

(51) Int. Cl. B23K 9/04; B23K 35/32

(52) U.S. Cl. CPC B23K 9/048; B23K 35/327

(57) ABSTRACT

The present invention provides a process and product for applying a hard coating to corrugated roller shells, and other roller shells having an irregular outer contact surface with raised portions. The roller, together with the welding electrode and associated particle feeder are movably attached to a fixture that allows them to move with respect to each other. The electrode is positioned at a starting location, actuated to form a weld puddle into which the particles are fed, and moved along an application path that follows the raised portions.

### BACKGROUND OF THE INVENTION

Field of the Invention

The present invention relates to the field of wear resistant machine parts, and more particularly to a pellet mill roller shell with a hard coating, and a method of applying the hard coating.

Description of Related Art

As can be seen by reference to the following U.S. Pat. No. 4,097,711 the prior art teaches a method of applying a hard coating including hard surfacing particles such as tungsten carbide, titanium carbide, and aluminum oxide. The '711 describes a process for hard coating a carbonized steel surface of a roller shell that has a uniform smooth outer contact surface. The hard coating is applied in narrow strips in a path around the circumference of the outer surface of the shell, with an interpass overlap, until the entire width of the shell surface is coated.

It is necessary to rotate the shell around allowing the shell to cool so that the hardfacing weld adheres to the substrate. Then on the next pass, to increase the toughness of the weld, it is necessary to slightly overlap the existing weld to join the two passes. The carburization of the shell pre and post heat treat made the surface very brittle so that it is critical not to have any edges when put into production.

To avoid failure under working conditions, the finished surface has to be relatively flat and free from peaks and valleys with absolutely no voids in the tungsten. It is necessary to coat the entire surface or the tungsten will pop off.

The rollers with a smooth surface do not provide good traction. Roller shells with corrugated surfaces, or other surfaces with raised portions, are desirable. However, when the method of the '711 patent has been used on roller shells having an outer surface with raised portions, such as corrugations, diamonds, dimples, etc., the hard coating does not stay attached long enough to make the shell a marketable product.

As a consequence of the foregoing situation, there has existed a longstanding need for a new and improved process for applying a hard coating to corrugated roller shells, and other roller shells, having an irregular outer contact surface, and the provision of such a process and product stated object of the present invention.

### BRIEF SUMMARY OF THE INVENTION

Briefly stated, the present invention provides a process and product for applying a hard coating to corrugated roller shells, and other roller shells having an irregular outer contact surface with raised portions. The roller, together with the welding electrode and associated particle feeder are movably attached to a fixture that allows them to move with respect to each other. The electrode is positioned at a starting location, actuated to form a weld puddle into which the particles are fed, and moved along an application path that follows the raised portions.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with drawings, wherein:

FIG. 1 is a partial perspective view illustrating the prior art process;

FIG. 2 is a partial perspective view illustrating the process of the present invention;

FIG. 3 is a sectional schematic view showing the start of the welding on one side of the roller;

FIG. 4 is a sectional schematic view showing the movement of the welding electrode across the roller;

FIG. 5 is a sectional schematic view showing the electrode moved to the opposite side of the roller;

FIG. 6 is a partial side elevational view showing the hard coating applied to the ridges of the corrugated roller shell;

FIG. 7 is a partial right side perspective view similar to FIGS. 2 and 6 showing a roller shell with ridges disposed perpendicular to the sides with open ends;

FIG. 8 is a partial right side perspective view similar to FIG. 7, but showing closed ends;

FIG. 9 is a partial right side perspective view showing a roller shell having diagonal ridges with open ends;

FIG. 10 is a partial right side perspective view similar to FIG. 9 but showing closed ends;

FIG. 11 is a partial right side perspective view of a roller shell having diamond-shaped raised portions;

FIG. 12 is a partial right side perspective view having circular shaped raised portions; and

FIG. 13 is a partial right side perspective view of a roller shell with diagonal ridges and open beveled ends.

### DETAILED DESCRIPTION OF THE INVENTION

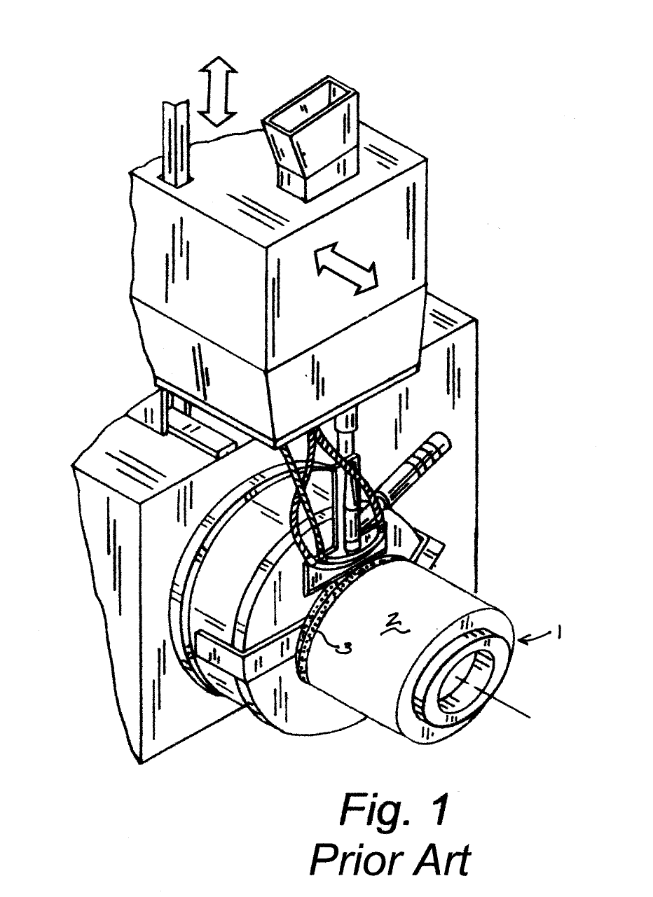

FIG. 1 illustrates the prior art process, as described in U.S. Pat. No. 4,097,711, which is incorporated herein by reference. The prior art process coats the roller shell (1) outer surface (2) with a hard surface (3) applied in narrow strips in an application path around the circumferences of the roller (1), with overlapping interpasses until the entire width of the roller surface (2) is coated;

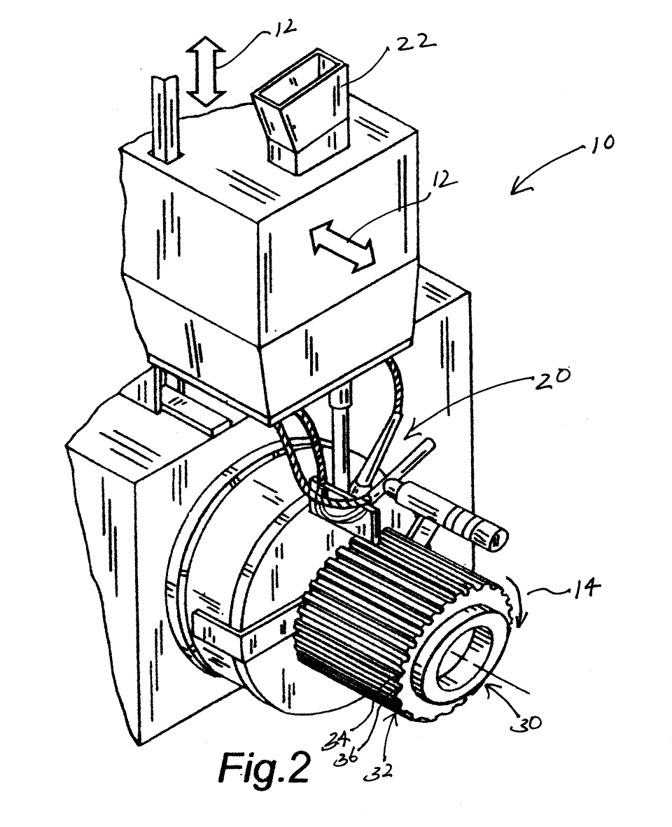

As can be seen by reference to the drawings, and in particular to FIG. 2, the process and product for applying a hard coating to corrugated roller shells, and other roller shells having an irregular outer contact surface, that forms the basis of the present invention is designated generally by the reference to number 10.

The fixture 10 is adapted to provide relative movement of the tools and/or workpieces that are mounted on the fixture 10, as illustrated by directional arrows 12 and 14. The welding tool 20 and the associated particle feeder 22 are mounted on the fixture 10, and are movable as generally indicated by directional arrows 12. The corrugated roller shell 30 is also mounted on the fixture 10, and is generally movable as shown by directional arrow 14. The fixture 10 thus provides relative movement of the welding tool 20 and the roller shell 30 that is needed to practice the method of the present invention.

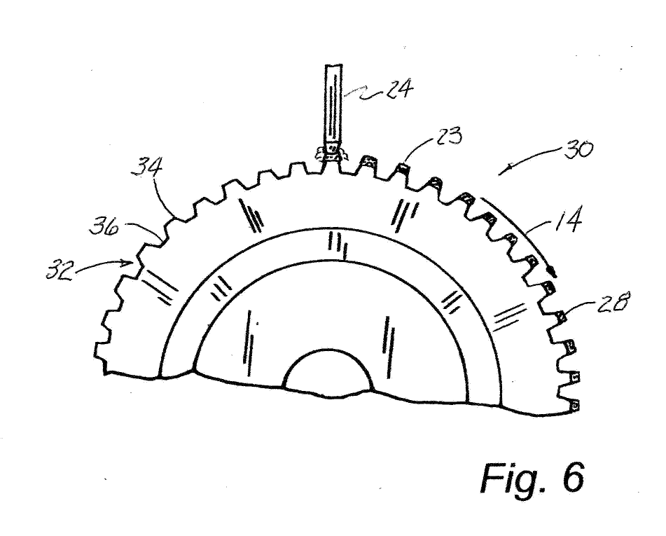

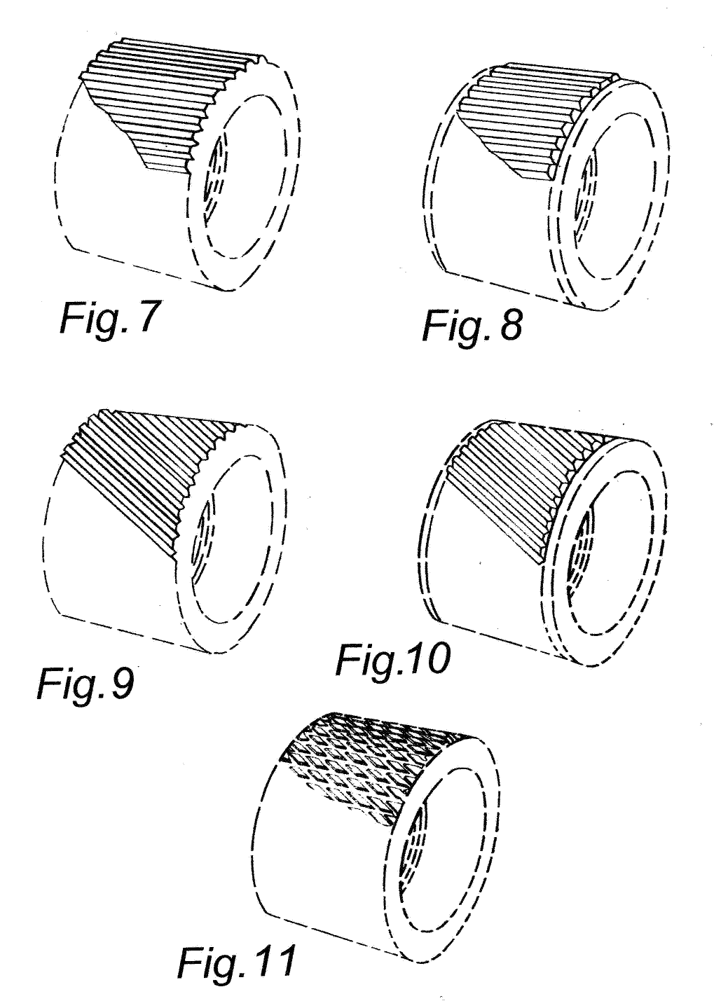

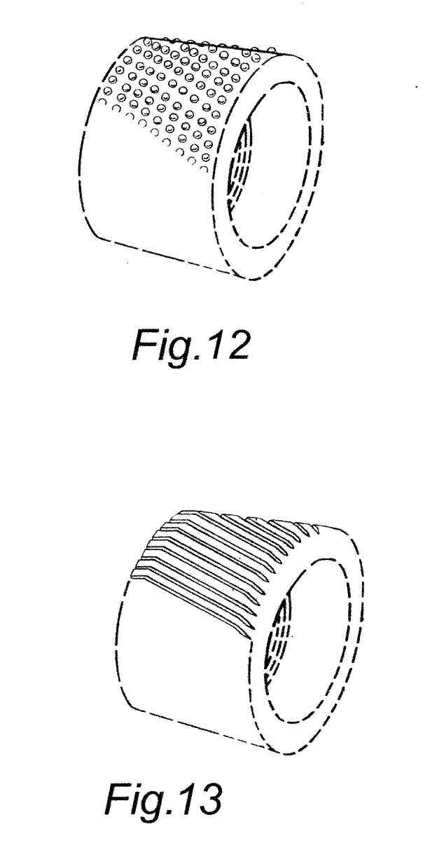

As best shown in FIGS. 2, 6 and 7, the roller shell 30 has an outer corrugated surface 32 that has alternating raised portions or ridges 34 and grooves 36. The corrugations extend across the width of the roller shell 30 perpendicular to the sides, and the grooves 36 are open at the sides. It is to be understood that the roller shell 30 could be variously designed to have the grooves 36 closed at the sides (FIG. 8), to have diagonal on helical ridges 34 and grooves 36 (FIG. 9—open end), (FIG. 13—open end and beveled edge), (FIG. 10—closed end), to have geometric shapes such as diamonds (FIG. 11), or circular raised portions 34 (FIG. 12) or to have other configurations that have raised portions 34.

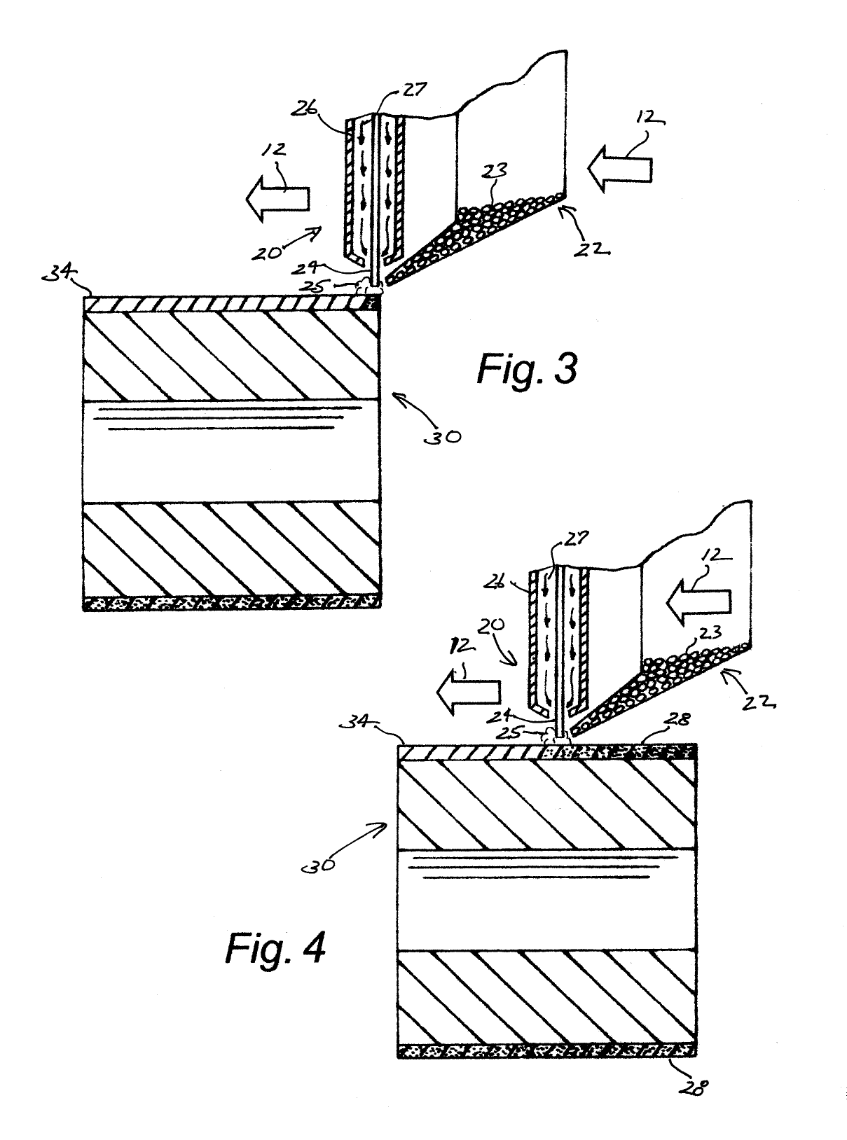

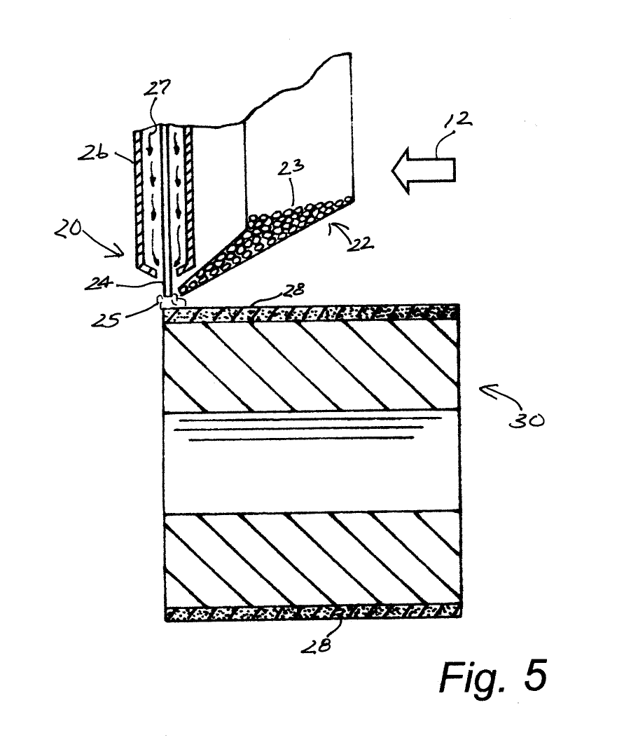

Referring now to FIGS. 3-5, the welding tool includes a non-consumable tungsten electrode 24 that creates a weld puddle 25 with a gas conduit 26 that directs an inert gas 27 to the weld area. The particle feeder 24 feeds 40 mesh tungsten carbide particles 23 at a controlled rate into the weld puddle 25 to provide a wear resistant hard surface 28. It is to be understood that other electrodes and/or other hard particles could be used in practicing the present invention.

FIGS. 3-5 illustrate the movement of the electrode 24 along an application path that follows the raised portion or ridge 34 across the width of the roller shell 30. The hard surface 28 thus formed adheres to the roller shell 30 in use and does not fail under working conditions. There is no need to completely cover the entire surface with the wear resistant layer, since the hard surface 28 and the raised portion 34 have a uniform joined substrate.

Controlling the application path to coincide with the raised portions 34 produces a corrugated roller shell 30 with a durable hardened surface without the need for a continuous coating over the entire surface. It is also believed that formation of durable hardened strips on any steel surface, smooth or irregular, can be achieved by controlling the parameters of the welding process. These parameters include a weld electric current in the range of about 160-180 amperes, a weld temperature in a range of about 10,000-14,000 degrees Kelvin, an Argon gas flow rate of about 15 liters per minute, and a tungsten carbide feed rate of about 1 Kg per hour.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A method of hard surfacing a steel roller having an outer surface with raised portions, the method comprising the steps of:
providing a fixture;
movably attaching an electrode and an associated particle feeder to the fixture;
movably attaching the roller to the frame;
providing relative movement of the electrode and the roller;
positioning the electrode at a starting location relative to a raised portion of the outer surface of the roller;
activating the electrode to create a weld puddle;
feeding particles into the weld puddle; and
moving the electrode and/or the roller with respect to the other along an application path that follows the raised portions of the outer surface of the shell.

2. The method of claim 1, wherein the particles are tungsten carbide.

3. The method of claim 2, wherein the particles are 40 mesh.

4. The method of claim 1, wherein the electrode is a non-consumable tungsten electrode.

5. The method of claim 1, wherein the outer surface of the shell is corrugated.

6. The method of claim 5, wherein the corrugated outer surface has alternating ridges and grooves that extend perpendicular to sides of the roller.

7. The method of claim 6, wherein the shell has closed ends.

8. The method of claim 5, wherein the corrugated outer surface has alternating ridges and grooves that extend diagonally to the sides of the roller.

9. The method of claim 8, wherein the roller has beveled edges.

10. The method of claim 8, wherein the roller has closed ends.

11. The method of claim 1, wherein the raised portions are diamond shaped.

12. The method of claim 1, wherein the raised portions are circular end shaped.

13. A hard surfaced steel roller made by the method of claim 1.

14. A method of hard surfacing a steel workpiece having a surface, the method comprising the steps of:
providing a fixture;
movably attaching an electrode and associated particle feeder to the fixture;
movably attaching the workpiece to the frame;
providing relative movement of the electrode and the workpiece;
positioning the electrode at a starting position relative to the surface;
activating the electrode to create a weld puddle;
controlling the weld electric current in the range of about 160-180 amperes;
controlling the weld temperature within a range of about 10,000-14,000 degrees Kelvin;
feeding an inert gas to an area surrounding the electrode at a rate of about 15 liters per minute;
feeding particles into the weld puddle, wherein the particles are fed at a controlled rate of about 1 Kg per hour; and
moving the electrode and/or the workpiece with respect to the other along a predetermined application path.

15. The method of claim 14, wherein the particles are tungsten carbide.

16. The method of claim 15, wherein the particles are 40 mesh.

17. The method of claim 14, wherein the electrode is a non-consumable tungsten carbide.

18. The method of claim 14, wherein the inert gas is Argon.

19. The method of claim 14, wherein the surface is uniformly smooth.
